(19) United States
(12) Patent Application Publication
(10) Pub. No.: US 2008/0091594 A1
(43) Pub. Date: Apr. 17, 2008

(54) LENDING AGAINST THE VALUE OF A LIFE INSURANCE POLICY

(76) Inventors: Richard G. Abramson, Los Angeles, CA (US); Stephen L. Gray, East Sussex (GB); Gene Simmons, Beverly Hills, CA (US); Maxim D.S. Steward, London (GB); William Randolph, New York, NY (US)

Correspondence Address: FISH & RICHARDSON P.C., P.O. BOX 1022, MINNEAPOLIS, MN, 55440-1022, US

(21) Appl. No.: 11/866,760

(22) Filed: Oct. 3, 2007

Related U.S. Application Data
(60) Provisional application No. 60/828,303, filed on Oct. 5, 2006.

(51) Int. Cl. G06Q 40/00

(52) U.S. Cl. 705/39; 705/35

(57) ABSTRACT

Loaning money includes determining a maximum loan amount based on a value of a life insurance policy. The value of the life insurance policy is linked to graduated basic amount-adjusted tables by age and sex predictive of at least one of the expectations of death or survivorship. The method includes providing a loan to the holder of the life insurance policy in an amount not greater than the determined maximum loan amount with the loan being secured by the life insurance policy.

### CROSS-REFERENCE TO RELATED APPLICATION(S)

This application claims the benefit of priority of U.S. Provisional Patent Application No. 60/828,303, filed on Oct. 5, 2006. The complete disclosure of that application is incorporated by reference herein.

### TECHNICAL FIELD

This disclosure relates to lending against the value of a life insurance policy.

### BACKGROUND

In the past, banks have issued non-recourse loans to fund the premiums to purchase life insurance policies with a view to selling the policies in the life settlement or other secondary markets once the contestability period (e.g., two years) inherent in the policies has lapsed. Such loans may be found to be wrongful because the insured is, by implication, initially represented as healthy with a view to representing himself as in poor health a short time later (e.g., two years later).

Life insurance policy owners also can borrow against the surrender value of their policies (i.e., the cash value payable upon surrender of the policy to the issuer). However, loans based on the surrender value of the policy typically are for an amount less than the open-market value of the policy.

### SUMMARY

Various aspects of the invention are set forth in the claims.

For example, in one aspect, a method of loaning money includes determining a maximum loan amount based on a value of a life insurance policy. The value of the life insurance policy is linked to graduated basic amount-adjusted tables by age and sex predictive of at least one of the expectations of death or survivorship. The method includes providing a loan to the holder of the life insurance policy in an amount not greater than the determined maximum loan amount with the loan being secured by the life insurance policy.

Various implementations include one or more of the following features. For example, the loan can be a recourse loan secured at least in part against the value of the life insurance policy. Determining the maximum loan amount can include using a “qx” value and can include factoring in the size of premium payments for the life insurance policy, the face value of the policy and the age and sex of the insured person. Preferably, determining the maximum loan amount based on the value of the life insurance policy is based on a non-medical estimation of life expectancy. The graduated basic amount-adjusted tables can be interlinked with banking loan-to-value assessments.

In some cases, reimbursement of an entity providing the loan in the event of default of repayment of the loan is covered at least in part by insurance.

In another aspect, a method includes providing a guarantee to a lender who provides a loan in an amount not greater than a previously-determined maximum loan amount. The maximum loan amount is based on a life insurance policy value that is linked to graduated basic amount-adjusted tables by age and sex predictive of at least one of the expectations of death or survivorship. The loan is secured by the life insurance policy. In some cases, the guarantee is collateralized by the life insurance policy.

Certain features can be implemented as part of an automated or computerized system. Likewise, various features can be implemented in an article comprising a machine-readable medium that stores machine-executable instructions for causing a machine to perform specified functions.

Other features and advantages will be apparent from the following detailed description, the accompanying drawings and the claims.

### BRIEF DESCRIPTION OF THE DRAWINGS

FIG. 1 illustrates an example of a process for issuing a loan according to the invention.

FIG. 2 illustrates another example of a process for issuing a loan according to the invention.

FIG. 3 illustrates an example of a process in the event the borrower defaults on the required loan payments.

FIG. 4 illustrates another example of a process in the event the borrower defaults on the required loan payments.

FIG. 5 illustrates an example of how the loan provisions can be incorporated into new policies.

FIG. 6 is an example of a screen shot for a web-enabled loan calculator.

### DETAILED DESCRIPTION

As explained below, the amount of a loan secured by a life insurance policy is linked to graduated basic amount-adjusted tables by age and sex predictive of the expectations of death and survivorship. Such techniques can be applied, for example, to recourse loans against the value of life insurance policies in excess of their surrender values with the loans secured primarily by the value of the policies. This can enable a policy owner to obtain a loan in excess of the surrender value of the policy. The recourse loans can be, but need not be, limited by the value of the policy.

As discussed in greater detail below, the value of a life insurance policy—for the purpose of determining a (maximum) loan amount—is based on several factors, including “qx” values, such as those in the RP-2000 mortality tables. Additional factors that are used in a preferred implementation include the amount of premium payments for the policy, the face value of the policy and the age and sex of the insured. Preferably, the insured's state of health is not used as a factor in determining the loan amount. Thus, the techniques for determining the loan amount preferably employ non-medical estimations of life expectancy. Nevertheless, the techniques can be adapted to take account of other factors typically considered by policy providers in the rating of individual policies. Such factors may include, for example, the health of the insured or other lifestyle factors.

The techniques disclosed herein may be used, for example, as a rider or policy term, in new life policies to replace or augment the surrender value as a basis for policy loan provisions over the period of the policy. The policy owner can, for example, obtain a loan in excess of the surrender value of the policy or the policy provider can lend against higher surrender values calculated using the techniques detailed above.

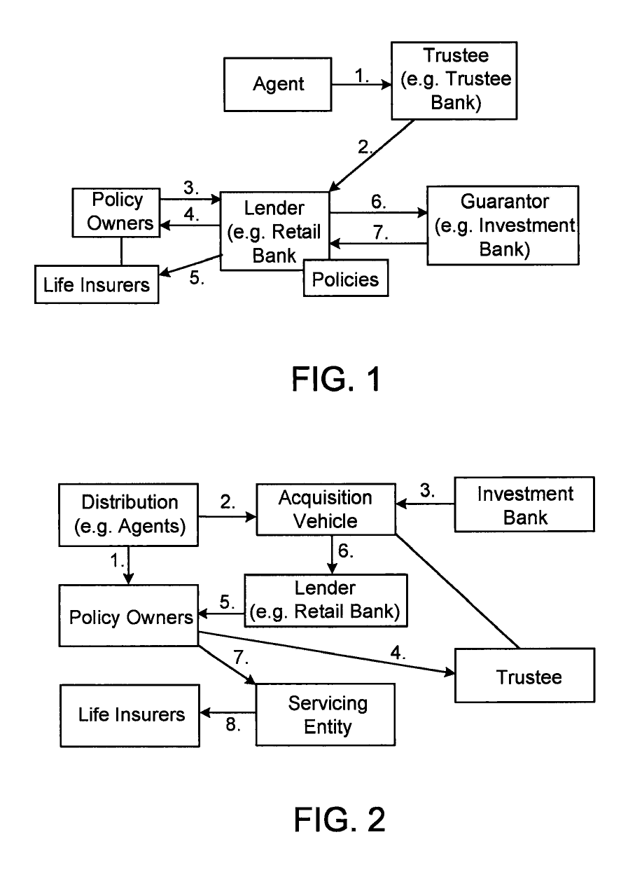

FIG. 1 illustrates an example of the overall process for issuing a loan. An agent conducts a pre-screening process to determine whether a particular life insurance policy holder meets the requirements for obtaining a loan against the policy and to determine a maximum loan amount. To facilitate determination of the maximum loan amount, an on-line web site may be used by prospective borrowers and/or the agent to provide an indication of the likely maximum loan they may be able to obtain from a lender (e.g., retail bank). Further details of such an on-line site are discussed below.

A trustee (e.g., trustee bank) verifies the loan information obtained from the agent. The retail bank or other lender then verifies the credit worthiness of the borrower and issues the loan. The life insurance policy is pledged against the loan and serves as collateral to protect the retail bank in the event the borrower defaults. Although the borrower retains ownership of the life insurance policy, physical possession of the policy is held either by the retail bank or the trustee. A guarantor (e.g., investment bank) may provide a guarantee to the retail bank in the event the borrower defaults. If such a guarantee is made, the retail bank would make premium payments to the investment bank.

During the term of the loan, the borrower makes premium and interest payments to the retail bank, which maintains and services the loan account. The retail bank passes the premium payments on to the life insurance company.

FIG. 2 illustrates another example of an overall process for issuing a loan. The distribution entity (e.g., an agent) can conduct a pre-screening process to determine whether a particular life insurance policy holder meets the requirements for obtaining a loan against the policy and to determine a maximum loan amount. To facilitate determination of the maximum loan amount, an on-line web site may be used by prospective borrowers and/or the distribution entity to provide an indication of the likely maximum loan they may be able to obtain from a lender (e.g., retail bank). Further details of such an on-line site are discussed below.

The acquisition vehicle (e.g., a finance company) ensures verification of the loan information obtained from the distribution entity. The retail bank or other lender then verifies the credit worthiness of the borrower and issues the loan. The retail bank sells the loan to the acquisition vehicle after issuing the loan. The life insurance policy is pledged against the loan and serves as collateral to protect the lender in the event the borrower defaults. Although the borrower retains ownership of the life insurance policy, physical possession of the policy is held by the trustee. An investment bank may lend money to the acquisition vehicle. If such money is made, the acquisition vehicle would make interest and capital payments to the investment bank.

During the term of the loan, the borrower makes premium and interest payments to the servicing entity, which maintains and services the loan account. The servicing entity passes the premium payments on to the life insurance company.

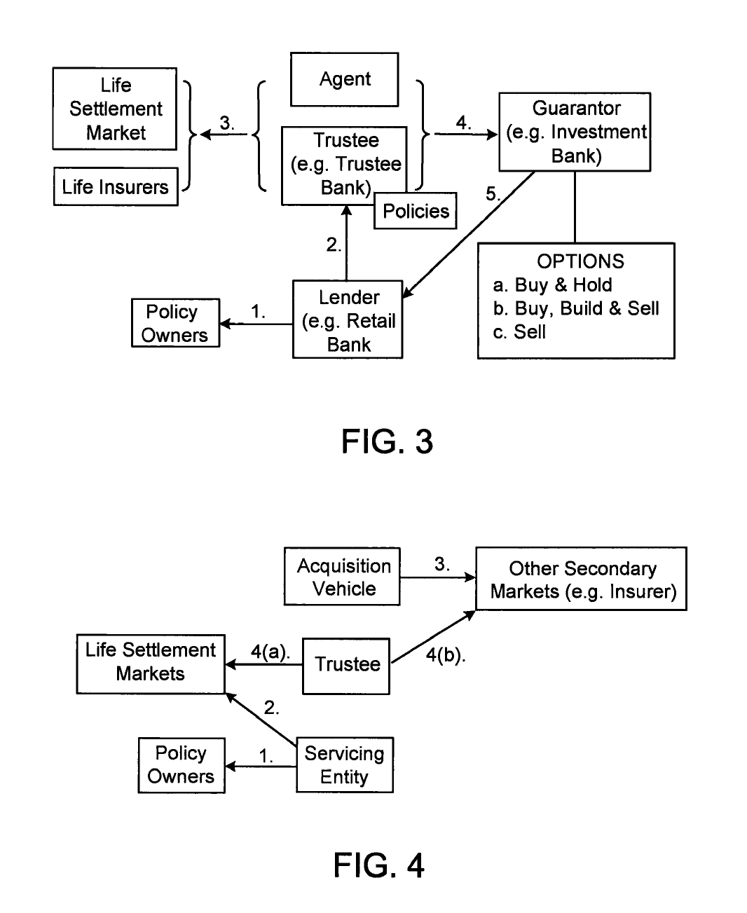

FIG. 3 illustrates an example of what occurs in the event the borrower defaults on the required loan payments. In the event of an uncured default by the borrower, the retail bank can foreclose on the defaulting policy owner and issue instructions and transfer policies to the trustee bank on behalf of the investment bank whose guarantee is being called. The trustee bank, in cooperation with the agent, would determine open market terms from the life settlement market for the sale of the policy.

Next, the investment bank would decide from among one or more options how it wishes to proceed. For example, the investment bank might choose to sell the policy. Alternatively, the investment might choose to buy the defaulting policy and continue to pay the premiums. In some cases, the investment bank may choose to acquire a portfolio of such policies that are in default and subsequently sell the portfolio in the open market. Any access of policy realization proceeds above the balance of the loan would be returned to the borrower. In the event the policy realizes less than the outstanding loan balance, the shortfall would be payable by the investment bank (as guarantor) to the retail bank or by the borrower (including accrued interest and collection fees and costs).

If the borrower should die during the period of the loan, then the outstanding amount of the loan (plus any unpaid, accrued interest) is deducted from the death benefit. The remaining amounts (if any) would go to the estate of the deceased.

FIG. 4 illustrates another example of what occurs in the event the borrow defaults on the required loan payments. In the event of an uncured default by the borrower, the servicing entity acting on behalf of the lender can foreclose on the defaulting policy owner. The servicing entity would determine the best open market terms for the sale of the policy in the life settlement market. The acquisition vehicle can seek to determine whether other secondary markets (e.g., the policy provider of the acquisition vehicle, if any) exist and whether such other markets are prepared to offer more to purchase the policy than the best open market terms.

The trustee can sell the policy at the best terms available in either the life settlement or from another secondary market. Any access of policy realization proceeds above the balance of the loan (including accrued interest and collection fees and costs) would be returned to the borrower. In the event the policy realizes less than the outstanding loan balance, the loss would be sustained by the acquisition vehicle which, in turn, may recover part or all of its loss from the borrower, the insurance company or the investment bank.

If the borrower should die during the period of the loan, then the outstanding amount of the loan (plus any unpaid, accrued interest) is deducted from the death benefit. The remaining amounts (if any) would go to the estate of the deceased.

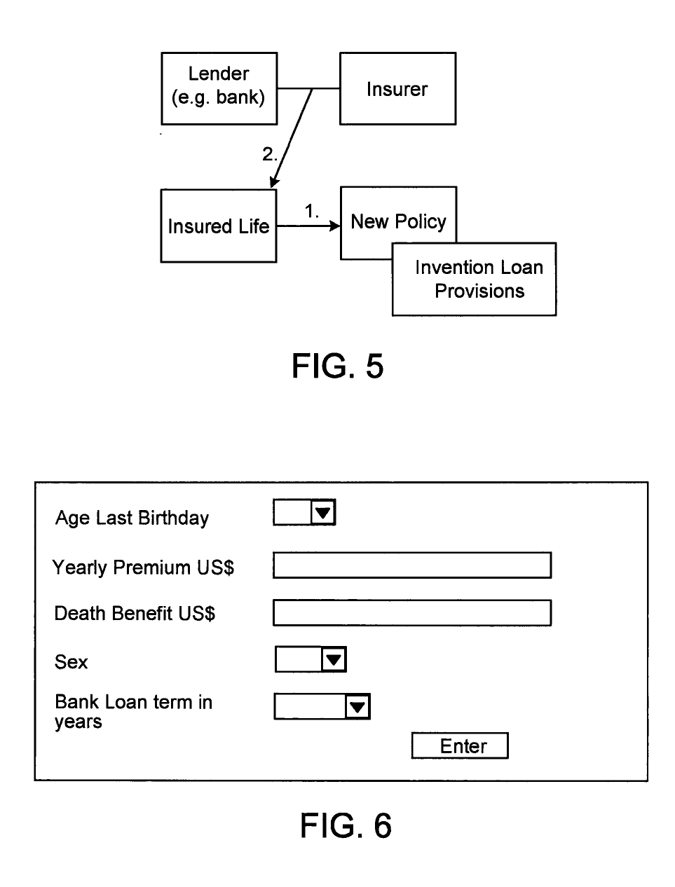

FIG. 5 illustrates an example of how the loan provisions can be incorporated into new policies. The life insurance policy provider can adopt the techniques of this disclosure in so far as they apply to the loan provisions of the policy by either using the techniques to calculate surrender values or limiting the techniques to the loan provisions of the policy. The loans typically will be higher using these techniques.

The insured life may be offered the opportunity, through the provisions of the policy, to borrow against the value of the policy with recourse limited, for example, to the value of the policy. When using these techniques of graduated basic amount-adjusted tables by age and sex predictive of the expectations of death and survivorship, policies are likely to become worth more the longer those policies are held. The borrower can, for example, increase the amounts it borrows against the policy as time progresses.

The policy provider may make the loans available itself or act in concert with a lender, for example a bank, which will make the loans. Interest payments on the loan may be payable by the borrower as due or added to the loan outstanding. The policy provider or lender, as applicable, would hold the policy as collateral, although the ownership of the policy would remain with the policy owner.

In the event of an uncured default by the borrower, the policy provider (or lender as applicable) can foreclose on the defaulting policy owner. The policy provider would recapture the policy on such default, and the obligations between the policy provider and the past-policy owner would be finished. The past-policy owner would be responsible for its own tax obligations if its default had triggered a tax event. The policy provider and the lender, if different entities, would settle their financial obligations between one another with or without recourse to the borrower.

If the borrower should die during the period of the loan, then the outstanding amount of the loan (plus any unpaid, accrued interest) is deducted from the death benefit. The remaining amounts (if any) would go to the estate of the deceased.

Determination of Loan Amount

The following paragraphs explain further details about how the loan amount is determined.

The “qx” values (expectation of death) used in the loan index are variable in real time to reflect changes to applicable mortality experience and expectations and also to reflect market conditions (e.g., supply and demand experience and expectations within the life settlement and other secondary markets and/or the reinsurance market place). They also are variable in real time to reflect changes to interest rates, discount rates or other lending criteria.

The ongoing annual estimations of longevity and mortality in the loan index are based on tables that provide a curve of amount-adjusted expectations of mortality/longevity by age and sex and including death expectation factors and their reciprocal survivorship factors. The loan index thus creates individual and interlinked estimations for each policy/person for each year. The loan index ages the participant population automatically each year, with the ability to adjust expectations without necessarily altering the factors by the insertion of actual data as experience is known. These mechanics allow for computer-driven calculations that evaluate policy worth by providing a reliable and statistically viable interlink to the banking parameters that need to be factored into calculating maximum loan sizes.

Examples of tables that include the following information are disclosed in the Provisional Patent Application identified above and are incorporated by reference herein: Assumptions; Single Decrement Tables for GPW Calculations; Multiple Decrement Tables for Loan Calculations; Loan Calculations; Portfolio Result; and Policy Number Results.

Comparison with Life Settlement and Investment Banking Industries

It is common practice within the life settlement and investment banking industries (when assessing policy values for non-recourse loans) to express life expectancy (LE) in terms of years and decimal parts of years. There is a flaw within such existing assumptions because individuals do not die on schedule—some will die earlier than predicted, and others will live longer.

There also is a mathematical problem with existing common practice and the LEs used within it, as illustrated by the following example. Consider a group of 78 year-old males all sharing the same birthday who have an expected lifespan of (according to LE measurements) of 11.35 years, which suggests that exactly half of such 78-year old males will reach 89.35. For those 78-year olds who survive to 89.35, the likelihood of death in any given subsequent year is higher than it was when the individual was 78-years old. LEs currently used by the life settlement and investment banking industries do not account for that issue. The index used in the present techniques does account for that issue. The real average life expectancy—using the same assumption as above (i.e., that half of the 78-year old males will reach 89.35 years) and using the same actuarial curve—is 10.85 years. Thus, while half of such males will still reach 89.35 years, the average will be lower: 88.85 years.

A common practice used within the life settlement industry can be expressed as:
ALE=LE,

where:
ALE=average life expectancy
LE=life expectancy (as current standard).
This formula is inaccurate. By way of comparison, to give an example of the loan index, for a 70-year old male, one might provide for expectation of survival in year one of 98.5621% and, therefore, a corresponding expectation of death in year one of 1.4379%. The surviving life would then have an increased expectation of death and reduced probability of survival each year beyond year one. In year two, now aged 71, the expectation of death using the same curve would be 1.5903% and a converse expectation of survival of 98.4097%. The two expectations of death/survivorship cannot be added together, but instead are interrelated. The prospect of death in year one (or part thereof) can be expressed as:

$$D = \frac{( AS \cdot ASqx ) \cdot days}{365.25}$$

where:
D=statistical probability of death during period
AS=age and sex of the life insured
ASqx=formula applicable to age and sex of life insured.

Year-2 death and survival rates are impacted by year-1 actual figures. That is because, for example, the same person cannot die twice. Year-1 survival probability (S) is calculated by deducting the probability of death (i.e., D−S) which allows for the following probability of death in year 2 (or part thereof):

$$D = \frac{S - ( AS \cdot ASqx ) \cdot days}{365.25}$$

where:
D=statistical probability of death during period
AS=age (one year older) and sex of the life insured
ASqx=formula applicable to age (one year older) and sex of life insured.

The loan index adjusts based on the surviving cohort each year. The more people remaining alive, the greater pool of lives to which the expectation of both death and survivorship apply. In the equation above, with the same formulae and ages as provided, D equals 1.5674%, which differs from the value of 1.5903% inherent in the equation ALE=LE.

The loan index can permit an agreed correlation of the policy value determined by the index and the maximum loan size that may be offered. The index can permit the borrower to alter, and have the calculations alter, the percentage it is willing to loan against value, its loan to value ratio, across all borrowers or just by sex, or just by age group or individual age, or by any combination of these factors.

The loan index can permit partial or wholesale movements in the factor(s) included to discount the policy value as determined. Examples of such factors include percentages of policy values. An interactive model can be provided to allow the user to alter assumptions so as to move the ratios of policy value to loan value.

The graduated basic amount-adjusted tables used to determine the loan amount can be interlinked with banking loan-to-value assessments. The core model, which represents an example, permits the lender to factor in a number of variants to address interest rate assumptions, discount factors and banking risks. The model shows examples that extend to permit immediate calculation of any number of the cost of hedging, present value (PV) assumptions, voluntary repayments, default probabilities, and movements to fees.

### EXAMPLE

The impact of a movement in the base lending rate of 50 bp (basis points) might, in turn, trigger a need for the lender to reassess the worth of policies on loans by 50 bp. For a 61-year old male with an ongoing premium of $2,000,000 per annum and a death benefit of $200 m, a loan against the policy of $34,279,119 would drop to $31,152,467 (based on the same longevity and other assumptions). Every one of the interlinked factors could, on its own, move the policy worth by at least 10%. The relationship between the factors and the methodology by which it is addressed permit instant touch-button changes to the calculations of policy worth and maximum loan sizes accurate, for example, to the dollar and minute.

The size of the loan may depend partly upon the age and sex of the potential borrower, taking into account the ongoing premium, death benefit, type of policy and policy age. The size of the loan also may depend on the ongoing banking assessment of present value and interest rate movements, the credit worthiness of age and sex cohort and of individuals specifically, the cost of hedging, insurance and fees.

Various implementations may include one or more of the following features:
The loan index can use, as its core, more accurate assumptions rather than less accurate life expectancy (LE) assumptions.
The loan index can permit partial or complete alterations to the ratio between policy worth and maximum loan amounts.
The loan index can be self-correcting, e.g., by resetting its survivorship cohort automatically to 100 at the start of each year of calculation.
The loan index can interlink banking parameters to longevity/mortality assumptions to facilitate assessing lending against this asset class (i.e., life insurance policies).
   Web-Enabled Loan Calculator

As mentioned above, to facilitate the determination of the maximum loan amount, an on-line interactive web site (or other network site) may be used by prospective borrowers and/or the agent to provide an indication of the maximum loan the policy holder may be able to obtain against the life insurance policy.

An example of a screen shot is shown in FIG. 6. The interactive screen allows a person to enter the policy owner's age, the yearly premium, the death benefit, the policy owner's sex and the desired term of the loan. Upon clicking the “Enter” button (using, for example, an electronic mouse or other device), the system calculates the maximum loan amount and displays that amount on the user's computer screen. To perform the calculation, the system uses the information from the qx and lending tables combined with information about the policy holder's ongoing premium obligations. The automated calculation feature can facilitate the pre-screening process.

Various aspects of a computer-implemented method may use hardware, software or a combination of hardware and software. Circuitry, including dedicated or general purpose machines, such as computer systems and processors, may be adapted to execute machine-readable instructions to calculate a loan amount according to the techniques described above. Computer-executable instructions for implementing the techniques can be stored, for example, as encoded information on a computer-readable medium such as a magnetic floppy disk, magnetic tape, or compact disc read only memory (CD-ROM).

Some implementations may allow the user to provide the required information, for example, by using a scroll choice such as drop-down menu. Techniques other than drop-down menus and other scroll options can be used to select and enter the required information. The information provided may include, for example, one or more of the following:

1. the type of policy (e.g., universal, individual, life).

2. the insured's gender.

3. the insured's month and year of birth.

4. the duration the policy has been in force (e.g., more than 5 years)

5. the dollar amount of policy face value (death benefit).

6. the dollar amount of the premium and the frequency of such premium payments (e.g., monthly).

7. the state of residency of the policy and/or insured.

8. the name of the policy provider.

Some implementations provide one or more of the following advantages.

For example, the first year premium and interest may be deducted at closing by the lender from the net loan offered. A policy owner seeking to sell will be able to compare the net loan offered with a life settlement offer. Where the two dollar figures are similar, such as may occur with healthy younger seniors, then loans under the disclosed technique may provide a logical option. With the insurance still in place, the borrower can revisit the choice. In contrast, a life settlement cannot be undone. Thus, even when the life settlement offer is higher, a policy owner still may find it advantageous to accept the lower amount offered under the loan according to the disclosed technique.

Loans according to the disclosed technique are asset-backed and, therefore, the interest rate can be relatively low. At a fraction of the cost of borrowing on credit cards, the loans can provide a prudent route to reduce interest burdens.

It often may make sounder sense to borrow using a life insurance policy as sole or main collateral instead of a home. There are no mortgages to record, no fees to title insurance companies for title searches and title insurance, and no mortgage recording taxes to pay. Like a house loan, the borrower can increase the loan as the asset becomes more valuable. At the end of the term of the loan, or earlier with agreement, the policy owner can seek a review of the policy worth with a view to refinancing, thus maintaining the policy and its tax advantages.

The current standard non-forfeiture laws, on which the typical calculation of surrender values are based, were introduced years ago and have actuarial formulae incorporated directly into the law. The expense allowances within these formulae do not differentiate between different types of policies. By recognizing and lending against a more accurate assessment of the policy value, the policy provider can increase sales and the consumer can benefit from higher policy loans incorporated into the improved products.

Other implementations are within the scope of the claims.

What is claimed is:

1. A method of loaning money comprising:
determining a maximum loan amount based on a value of a life insurance policy, wherein the value of the life insurance policy is linked to graduated basic amount-adjusted tables by age and sex predictive of at least one of the expectations of death or survivorship; and
providing a loan to the holder of the life insurance policy in an amount not greater than the determined maximum loan amount, wherein the loan is secured by the life insurance policy.

2. The method of claim 1 wherein the loan is a recourse loan secured at least in part against the value of the life insurance policy.

3. The method of claim 2 wherein the loan is a recourse loan limited to the value of the life insurance policy.

4. The method of claim 2 wherein the loan is a recourse loan not limited to the value of the life insurance policy.

5. The method of claim 2 wherein the size of the loan is in excess of its surrender value.

6. The method of claim 1 wherein determining the maximum loan amount includes using a “qx” value.

7. The method of claim 6 wherein determining the maximum loan amount based on the value of the life insurance policy comprises factoring in the size of premium payments for the life insurance policy, the face value of the policy and the age and sex of the insured person.

8. The method of claim 7 wherein determining the maximum loan amount based on the value of the life insurance policy is based on a non-medical estimation of life expectancy.

9. The method of claim 1 wherein determining the loan amount is based on a loan index in which annual estimations of longevity and mortality in the loan index are based on tables that provide a curve of amount-adjusted expectations of mortality/longevity by age and sex and that include at least one of death expectation factors or their reciprocal survivorship factors.

10. The method of claim 1 wherein determining the maximum loan amount is based on a loan index in which “qx” values in the loan index are variable in real time to reflect changes to applicable mortality experience and expectations.

11. The method of claim 1 wherein determining the maximum loan amount is based on a loan index in which “qx” values in the loan index are variable in real time to reflect changes to interest rates, discount rates or other lending criteria.

12. The method of claim 1 wherein the graduated basic amount-adjusted tables are interlinked with banking loan-to-value assessments.

13. The method of claim 1 wherein reimbursement of an entity providing the loan in the event of default of repayment of the loan is covered at least in part by insurance.

14. A method comprising receiving a loan in an amount not greater than a pre-determined maximum loan amount, wherein the loan is received by a holder of a life insurance policy, and wherein the pre-determined maximum loan amount is based on a value of the life insurance policy, the value of the life insurance policy being linked to graduated basic amount-adjusted tables by age and sex predictive of at least one of the expectations of death or survivorship, and wherein the loan is secured by the life insurance policy.

15. A method comprising providing a loan to the holder of the life insurance policy in an amount not greater than a pre-determined maximum loan amount, wherein the pre-determined maximum loan amount is based on a value of the life insurance policy, wherein the value of the life insurance policy is linked to graduated basic amount-adjusted tables by age and sex predictive of at least one of the expectations of death or survivorship, and wherein the loan is secured by the life insurance policy.

16. An article comprising a machine-readable medium that stores machine-executable instructions for causing a machine to:
determine a maximum loan amount based on a value of a life insurance policy, wherein the value of the life insurance policy is linked to graduated basic amount-adjusted tables by age and sex predictive of at least one of the expectations of death or survivorship.

17. The article of claim 16 including machine-executable instructions for causing the machine to determine the maximum loan amount in response to user input.

18. The article of claim 17 wherein the user input includes information indicative of the age and sex of the insured, size of premium payments for the life insurance policy, and face value of the life insurance policy.

19. The article of claim 16 including machine-executable instructions for causing the machine to determine the maximum loan amount based on a “qx” value.

20. The article of claim 16 including machine-executable instructions for causing the machine to determine the maximum loan amount by factoring in the size of premium payments for the life insurance policy, the face value of the policy and the age and sex of the insured person.

21. The article of claim 16 including machine-executable instructions for causing the machine to determine the loan amount based on a loan index in which annual estimations of longevity and mortality in the loan index are based on tables that provide a curve of amount-adjusted expectations of mortality/longevity by age and sex and that include at least one of death expectation factors or their reciprocal survivorship factors.

22. The article of claim 16 including machine-executable instructions for causing the machine to determine the maximum loan amount based on a loan index in which “qx” values in the loan index are variable in real time to reflect changes to applicable mortality experience and expectations.

23. The article of claim 16 including machine-executable instructions for causing the machine to determine the maximum loan amount based on a loan index in which “qx” values in the loan index are variable in real time to reflect changes to interest rates, discount rates or other lending criteria.

24. A method comprising:
providing a guarantee to a lender who provides a loan in an amount not greater than a previously-determined maximum loan amount, wherein the maximum loan amount is based on a life insurance policy value that is linked to graduated basic amount-adjusted tables by age and sex predictive of at least one of the expectations of death or survivorship, and wherein the loan is secured by the life insurance policy.

25. The method of claim 24 wherein the guarantee is collateralized by the life insurance policy.
